(19) United States
(12) Patent Application Publication
(10) Pub. No.: US 2021/0032175 A1
(43) Pub. Date: Feb. 4, 2021

(54) Novel Soil Amendment with Reduced Metal Content for Reducing Metal Uptake by Growing Plants, and Processes for Making and Using Same

(71) Applicant: David Abecassis, Huntington Station, NY (US)

(72) Inventor: David Abecassis, Huntington Station, NY (US)

(21) Appl. No.: 16/930,357

(22) Filed: Jul. 16, 2020

Related U.S. Application Data
(60) Provisional application No. 62/874,726, filed on Jul. 16, 2019.

(51) Int. Cl. C05F 17/20; C05F 1/00; C05F 17/60; C05F 17/80; A01C 21/00

(52) U.S. Cl. CPC C05F 17/20; C05F 1/002; A01C 21/00; C05F 17/80; C05F 17/60

(57) ABSTRACT

Streptobacillus is grown on purified chitin obtained by fermentation of micronized shrimp or crab shell material and purification using alkaline media. The chitin is biodegraded by the Streptobacillus and produces plant growth hormones or auxins. From 25 to 50% of the biomass is converted to the auxins. Since the soil amendment including the auxins has a low trace metal content, the soil amendment does not contribute to metal uptake by the treated growing plants. For example, Cannabis plants with a reduced trace metal content can be grown in soil media provided with the soil amendment with an 8 to 10 fold increase in root mass and root growth rates in order to comply with legal limits on the content of trace metals in the plants.

### CROSS-REFERENCE TO RELATED APPLICATIONS

This utility application is a continuation-in-part of U.S. Provisional Patent Application Ser. No. 62/874,726, filed Jul. 16, 2019, which is hereby incorporated in the following disclosure in its entirety. This continuation-in-part application claims the benefit of priority for that part of the inventions described herein below that is also described in U.S. Provisional Patent Application Ser. No. 62/874,726 under 35 U.S.C. § 119 (e).

### BACKGROUND OF THE INVENTION

### 1. The Field of the Invention

The present invention relates to an improved process of producing a soil amendment with a reduced metal content that promotes reduced uptake of trace metals by growing plants, particularly by plants growing in natural and artificial soil media provided with the soil amendment, and, more particularly, to an improved process of making a soil amendment that reduces uptake of metals by plants growing in soil media treated with the soil amendment when the soil amendment increases root mass and root mass growth rates so that they are several times greater than normal root mass and root grow rates occurring without the presence of the soil amendment.

The present invention also relates to a novel soil amendment with a reduced metal content that increases the root mass and root mass growth rates of plants grown in soil media treated with the novel soil amendment when the root mass and root growth rates are increased so that they are several times greater than normal growth rates occurring without treatment of the soil media with the soil amendment and the growing plants have a reduced metal content, especially a reduced trace metal content.

The present invention also relates to a soil amendment for growing plants with a reduced metal content, which contains an economically produced plant auxin or growth hormone that promotes plant growth and increases root mass, so that uptake of metals by the growing plants, especially Cannabis plants and cabbage plants, is reduced.

### 2. Description of the Related Art

Many organic fruits and vegetables uptake trace metals as part of their metabolism. In certain plants, especially hemp plants such as Cannabis, where metal uptake is high, there is concern regarding the effects of the metals taken up by the growing plants, especially when the harvested plant is subject to solvent extraction, because there are concerns about the long term effects of consumption of harvested plant products containing comparatively high amounts of trace metals.

Some states in the USA have restrictions on the amounts of certain trace or trace heavy metals that may be present in a Cannabis plant. The new process of the present application reduces the amounts of these undesirable metals in the Cannabis plant in order to comply with state legal requirements.

Soil amendments are known in the farming and horticulture arts to provide soil with better properties for growing plants and/or for improving the yields of a crop and/or the quality of the plants that are grown. The size and growth rate of various plants can be increased by adding a soil amendment to the soil media or growing media in the vicinity of the roots of the plants.

However, some soil amendments that will improve plant size or growth rate may comprise disadvantageously large amounts of metals, especially trace metals, which may exceed the legally required limits for these metals. Thus, there is a need for soil amendments that provide good results for growing plants and reduce the uptake of undesirable trace metals by the growing plants.

### The Objects of the Invention

It is an object of the present invention to provide a novel soil amendment with a reduced metal content that increases the root mass and root mass growth rates of plants grown in soil media treated with the novel soil amendment, but without increasing the metal content, particularly the trace metal content, of the grown plants.

It is a further object of the present invention to provide a novel low cost, rapid, and efficient process for making the aforesaid soil amendment of the present invention with the aforesaid benefits.

It is an additional object of the present invention to provide a novel process for growing plants, such as cabbage plants or Cannabis plants, in the presence of a soil amendment that greatly increases the root mass and root mass growth rates of the growing plants, but has a reduced metal content so that the uptake of the metals by the growing plants is reduced, in order to comply with legal requirements for metal content of harvested plants.

It is yet another object of the present invention to provide a process for growing plants, such as cabbage plants or Cannabis plants, in natural or artificial soil media with a novel soil amendment that increases the root mass and root mass growth rates of the plants several fold over the root mass and root mass growth rates for the same plants grown in the same soil media but without the novel soil amendment of the present invention, while simultaneously reducing the metal content, especially the trace metal content, of the plants grown with the assistance of the soil amendment.

### BRIEF SUMMARY OF THE INVENTION

In one aspect of the present invention, which satisfies the above-described objects, and others which will be made more apparent herein after, a first process of making a soil amendment with a reduced metal content, which increases root mass and root mass growth rates of plants grown in soil media provided with the soil amendment, comprises:

a) growing a thermo-tolerant auxin-producing Streptobacillus and/or Streptococcus on pure chitin in situ in natural and/or artificial soil media under aerobic conditions; and

b) biodegrading the pure chitin in the presence of ample oxygen and the auxin-producing Streptobacillus and/or Streptococcus, so as to form the soil amendment with the reduced metal content, which acts to increase the root mass and root growth rates of plants growing in said soil media.

The auxins or plant hormones in the soil amendment produced by the biodegradation have been determined and characterized as 3-4-deoxyglucosamine monomer, and its dimer.

Alternatively, another process for making the soil amendment with a reduced metal content, which increases root mass and root mass growth rates of plants grown in soil media provided with the soil amendment comprises:
a) making an aqueous suspension of chitin in aerated and/or oxygenated aqueous media; and
b) seeding or inoculating the aqueous suspension of chitin with an auxin-producing Streptobacillus derived from shrimp and/or crab meal fermentation to form culture or grow the Streptobacillus on the chitin; and
c) after a predetermined time of at least 24 hours biodegrading the chitin by means of the Streptobacillus to produce the soil amendment comprising the plant auxins.

In a further alternative process of making a soil amendment with a reduced metal content, which increases root mass and root mass growth rates of plants grown in soil media provided with the soil amendment, the process comprises:
fermenting or boiling an oxygenated aqueous suspension of micronized shrimp and/or crab shell pieces continually supplied with ample air or oxygen in order to spontaneously bloom a plant-auxin-producing Streptobacillus that coats the shrimp and/or crab shell pieces in the suspension; and
biodegrading the shrimp and/or crab cell pieces after a predetermined time to form the soil amendment, which consists essentially of the plant auxins formed during the biodegrading.

Other aspects of the present invention include the soil amendments that are made by the above-described alternative processes and also methods of growing plants in soil media with the soil amendments with reduced metal content, particularly reduced trace metal content, so as to increase the root mass and root mass growth rates of plants grown in that soil media.

Various methods of effectively providing plants growing in natural or artificial soil media with a soil amendment so that their root mass and root mass growth rate are increased are known from the prior art.

For example, the soil amendment of the present invention, which comprises 3-4-deoxyglucosamine monomer, and its dimer, could be leached into roots (root absorption) from the wet powder resulting from making the auxins in situ. Other methods include leaf absorption and use of hydroponics, i.e. mineral nutrient solutions containing the auxins.

The term “soil amendment” is well known in the horticulture and farming arts. By definition the term “soil amendment” means a non-nutrient plant additive for improving plant growth and plant properties—in the case of the present invention the soil amendment additive increases root mass and root growth rates but without increasing the metal content of the grown plants because of a reduced presence of the metals in the soil amendment.

### DESCRIPTION OF THE PREFERRED EMBODIMENTS

Preferred embodiments of processes for making the soil amendment with reduced metal content are described herein below.

During the first process, in which the soil amendment is produced in situ in soil media in which the plants are grown prior to or during the growing of the plants, pure chitin is preferably seeded or inoculated with the auxin-producing Streptobacillus at the beginning of or during the growing or culturing step a). A Streptococcus also may be used.

In a preferred embodiment of the first process the pure chitin may be obtained by fermentation of shrimp and/or crab shell material or by boiling the shrimp and/or crab shell material in water, e.g. tap water or sea water.

Prior to fermentation or boiling in water the shrimp and/or crab shell material is advantageously first micronized to particle sizes of 5 to 100 microns when performing the first process described in the above Summary.

To obtain the pure chitin used in step a) of the above first process the chitin initially obtained from the fermentation or the boiling of the shrimp and/or crab shell material is extracted with alkaline media to remove metals to purify the chitin, in order to reduce the metal content of the plant amendment. Also, the micronized shrimp and/or crab shell material may be extracted with alkaline media to reduce the metal content of the amendment.

During the first process of making the soil amendment 25 to 50% of a biomass consisting of a total amount of the reaction mixture containing the chitin and the Streptobacillus and/or Streptococcus is converted to plant auxins or growth hormones for stimulating growth of root mass of growing plants. The plant auxins are 3-4-deoxyglucosamine monomer, and a dimer thereof.

In a preferred embodiment of the first process a plurality of doses, each consisting of a predetermined amount, for example from 5 to 30 grams, of the pure chitin, are spread over and in the natural and/or artificial soil media prior to and/or during the growing plants of step a), in the vicinity of growing plants. The soil media should be moistened with water and ample air or oxygen should be provided during growth for culturing the Streptococcus on the chitin. The spreading of soil amendment of the invention may be by top-dressing a surface of said soil media in the vicinity of said plants.

Alternatively, in the first process the pure chitin consists essentially of micronized shrimp and/or crab shell material with a particle size of from 5 to 100 microns that has been extracted with alkaline media to reduce trace heavy metal content.

In other embodiments of the first process the pure chitin that is used to start the process may include or be derived from other natural sources including squid beaks and fungi. It is conceivable that the chitin could be manufactured by an artificial chemical process.

In the case of the second alternative of the process for making the soil amendment in which the chitin is first processed to produce the soil amendment with the growth stimulating auxins and reduced metal content and then later added to the soil in which the plants are growing, a preferred embodiment includes spinning an aqueous chitin suspension of chin particles in water, such as sea water, and continually supplying air or oxygen to the chitin suspension to ensure the presence of ample oxygen amounts during spontaneous development of the auxin-producing Streptobacillus on the respective chitin particles in the suspension. After spinning the suspension for a predetermined time, for example 24 hours, biodegradation of the chitin takes place to produce the soil amendment comprising the plant auxins that increase root mass and root mass growth rates. The auxins have been characterized chemically and comprise 3-4-deoxyglucosamine monomer, and a dimer thereof.

To ensure that the soil amendment of this second process has a reduced metal content the chitin may be extracted for example with alkaline media to reduce the naturally occurring metal content in the chitin. The initial source of the chitin may be a micronized shrimp and/or crab shell particulate.

In the third alternative process for making the soil amendment according to the invention an oxygenated aqueous suspension of shrimp and/or crab shell pieces is continually supplied with ample oxygen is fermented or boiled in water, in order to spontaneously bloom a plant-auxin-producing Streptobacillus that coats the shrimp and/or crab shell pieces in the suspension, so that the Streptobacillus biodegrades the shrimp and/or crab shell pieces after a predetermined time, e.g. 24 hours.

One preferred embodiment of this third process includes spinning an aerated or oxygenated aqueous suspension of micronized shrimp and/or crab shell pieces with a particle size of 5 to 100 microns in water, such as tap water or sea water, and continually supplying air or oxygen to the suspension to ensure the presence of ample oxygen amounts during spontaneous blooming or development of the auxin-producing Streptobacillus on the shrimp and/or crab shell particles in the suspension. After spinning the suspension for a predetermined time, for example 24 hours, biodegradation of chitin in the particles takes place to produce the soil amendment comprising plant auxins that increase root mass and root mass growth rates without an unacceptable uptake of metals by the growing plants.

As noted above, the auxins have been characterized chemically and comprise 3-4-deoxyglucosamine monomer, and a dimer thereof.

### BRIEF DESCRIPTION OF THE DRAWING

The objects, features and advantages of the invention will now be illustrated in more detail with the aid of the following examples, with reference to the accompanying figures in which:

FIG. 1 is a photograph of cilantro plants grown in natural soil without any soil amendments; and

FIG. 2 is a photograph of the same type of cilantro plants grown in the same natural soil as in FIG. 1, but with an effective amount of the soil amendment according to the present invention (comprising 3-4-deoxyglucosamine monomer and its dimer) added to the natural soil, which shows the effectiveness of the soil amendment of the invention in growing larger cilantro plants under the same conditions as the smaller cilantro plants shown in FIG. 1.

### EXAMPLES

### Example 1: Comparison of the Size of Cilantro Plants Grown in Soil Media with and without the Soil Amendment of the Invention

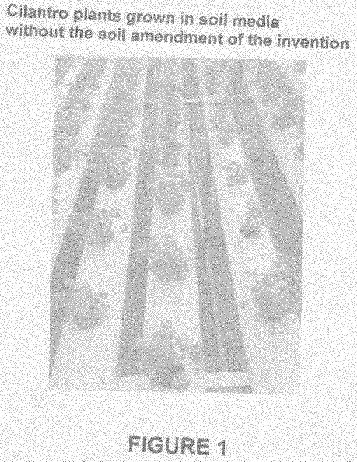

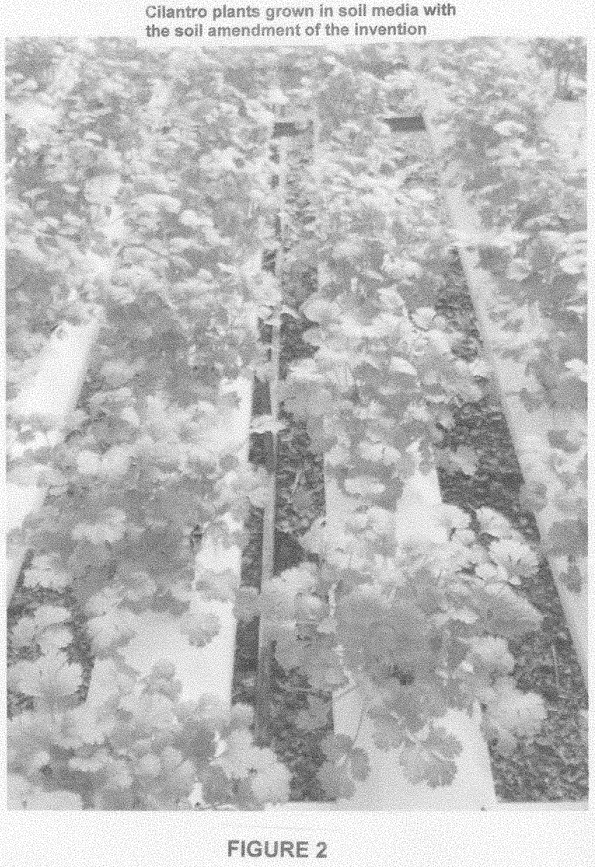

FIGS. 1 and 2 compare the sizes of cilantro plants grown with and without the soil amendment according to the claimed invention under the same conditions. FIG. 1 shows the control group.

The soil amendment according to the invention used to grow the plants shown in FIG. 2 contains an effective amount of the plant auxins (comprising 3-4-deoxyglucosamine monomer and its dimer) produced by biodegradation of pure chitin obtained by fermentation of micronized shrimp or crab shell material as described herein above using a Streptobacillus microorganism. FIG. 2 shows the effective results of adding the soil amendment according to the invention to the soil media in the vicinity of the cilantro plants.

The cilantro plants shown in FIG. 2 are clearly several times larger than the cilantro plants shown in FIG. 1 (control group), which proves that plants grown in soil media having the soil amendment according to the invention are many times more larger than those grown in the soil media without the applicant's soil amendment. Thus, cilantro plants grown with the soil amendment according to the invention have larger root mass under otherwise identical growing conditions.

A video is available from the applicants shows the structure of the larger root ball of the grown cilantro plants of FIG. 2.

Example 2 In addition to the above tests of the effectiveness of the soil amendment according to the invention in promoting growth of root mass and root mass growth rates, samples of the soil amendment were subjected to an elemental analysis by ProVerde Laboratories, Inc., 420 Fortune Blvd., Milford Mass. 01757. The tests were performed in accordance with the requirements of ISO/IEC 17025 and they showed that none of the 25 elements, (mostly metals), were present in an amount greater than an environmentally acceptable allowed maximum amount. The results for some of the most environmentally critical metal elements are shown in the following Table I.

TABLE I
Amounts of Critical Metal Elements Found in a Sample
of the Soil Amendment According to the Invention

| | | Conc,* | LLD, | Limit,** | |
|---|---|---|---|---|---|
| Metal | Symbol | (ppm) | (ppm) | (ppm) | Status |
| Magnesium | Mg | 265.7 | 0.50 | | Pass |
| Chromium | Cr | 1.13 | 5.0 | 45 | Pass |
| Nickel | Ni | 1.49 | 0.50 | 1.50 | Pass |
| Copper | Cu | 1.19 | 0.50 | 3.10 | Pass |
| Zinc | Zn | 1.06 | 5.00 | 15.0 | Pass |
| Arsenic | As | 0.03 | 0.004 | 15 | Pass |
| Cadmium | Cd | 0.01 | 0.001 | 5 | Pass |
| Mercury | Hg | <0.0 | 0.002 | 9 | Pass |
| Lead | Pb | 0.22 | 0.002 | 400 | Pass |

*ND, none detected to lowest limits of detection (LLD)
**Limits according to MA Dept. of Public Health, Environmental Media Protocol for Growing Media, Exhibit 4

Other samples confirmed the conclusion that the soil amendment of the environmental is environmentally acceptable according to MA state standards.

### Example 3: Exemplary Methods of Making the Soil Amendment According to the Invention

Shrimp shell material or shrimp meal is micronized to a particle size of 5 to 100 microns. The resulting particulate is purified, e.g. by extraction with an alkaline solution and other procedures as needed to obtain a pure chitin particulate.

The pure chitin particulate is introduced to a spinning aerated gallon of salt water (5 grams per gallon of water). After 24 hours an auxin producing Streptobacillus that blooms on the pure chin particulate biodegrades the pure chitin to form the auxins comprising 3-4-deoxyglucosamine monomer and its dimer.

While illustrative examples of one or more embodiments of the present invention are provided hereinabove, those skilled in the art and having the benefit of the present disclosure will appreciate that further embodiments may be implemented with various changes within the scope of the present invention. Other modifications, substitutions, omissions and changes may be made in the choice of plants grown, the root enhancing auxin and its amount, the nature of the soil media in which the plants are grown and the type and amounts of the metal contaminants as well as the process conditions that reduce contaminating metals, without departing from the spirit of the inventive process.

Accordingly, the breadth and scope of the present disclosure should not be limited by any of the above-described exemplary embodiments, but should be defined only in accordance with the following claims and their equivalents.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

What is claimed is:

1. A process of making a soil amendment with a reduced metal content, said soil amendment increasing root mass and root mass growth rates of plants grown in soil media provided with the soil amendment, said process comprising:
a) growing thermotolerant Streptobacillus and/or Streptococcus on pure chitin in situ in natural and/or artificial soil media under aerobic conditions; and
b) biodegrading said chitin with the Streptobacillus and/or Streptococcus in the presence of ample air or oxygen, so as to form the soil amendment with the reduced metal content, said soil amendment acting to increase the root mass and root growth rate of the plants grown in said soil media.

2. The process as defined in claim 1, further comprising seeding or inoculating said pure chitin of step a) with said Streptobacillus and/or Streptococcus.

3. The process as defined in claim 1, in which the pure chitin is obtained by a method comprising fermentation of shrimp and/or crab shell material or by another method comprising boiling the shrimp and/or crab shell material in water.

4. The process as defined in claim 3, wherein said shrimp and/or crab shell material is first micronized to particle sizes of from 5 to 100 microns prior to said fermentation or said boiling in water, and is then fermented or boiled.

5. The process as defined in claim 3, wherein the pure chitin of step a) initially obtained from the fermentation or the boiling in water is extracted with alkaline media to reduce metal content prior to obtaining the pure chitin and thus to reduce the metal content of the soil amendment.

6. The process as defined in claim 1, wherein 25 to 50% of a biomass is converted to plant auxins or growth hormones that stimulate growth of the root mass of the plants, wherein said biomass is the a amount of a process mixture comprising the chin, the Streptobacillus and/or Streptococcus, and the plant auxins.

7. The process as defined in claim 1, further comprising spreading a plurality of doses, each consisting of from 5 to 30 grams of said pure powdered chitin, in the natural and/or artificial soil media prior to and/or during said growing of step a), in the presence of said plants.

8. The process as defined in claim 7, wherein said spreading is by top-dressing a surface of said soil media in the vicinity of said plants.

9. The process as defined in claim 1, wherein said pure chitin consists essentially of micronized shrimp and/or crab shell material having a particle size of from 5 to 100 microns.

10. The process as defined in claim 9, wherein the shrimp and/or crab shell material has been purified by extraction with an alkaline media.

11. The process as defined in claim 1, wherein said pure chitin is obtained by purification of raw chitin from other chitin sources, said other sources including squid beaks and/or fungi.

12. A soil amendment with a reduced metal content, said soil amendment increasing root mass and root mass growth rates of plants grown in soil media provided with the soil amendment, wherein said soil amendment is made by a process comprising:
a) growing or forming thermotolerant Streptobacillus and/or Streptococcus on pure chitin in situ in natural and/or artificial soil media under aerobic conditions; and
b) biodegrading said chitin with the Streptobacillus and/or Streptococcus in the presence of ample air or oxygen, so as to form the soil amendment with the reduced metal content, said soil amendment acting to increase the root mass and root growth rate of said plants growing in said soil media, while reducing metal uptake by said plants.

13. The soil amendment as defined in claim 12, wherein said pure chitin of step a) consists essentially of micronized shrimp and/or crab shell materials with a particle size of from 5 to 100 microns.

14. The soil amendment as defined in claim 13, wherein the micronized shrimp and/or crab shell materials have been purified by extraction with an alkaline media, in order to reduce the metal content of said soil amendment.

15. The soil amendment as defined in claim 12, wherein said process further comprises seeding or inoculating said pure chitin of step a) with said Streptobacillus and/or Streptococcus and culturing said pure chitin on said pure chitin after wetting said chitin.

16. The soil amendment as defined in claim 12, whereby the plants growing in the soil media including the soil amendment have a root mass and a root mass growth rate that is from 6 to 10 times greater than the root mass and the root mass growth rate of a control group of the same type of plants growing in the soil media without the soil amendment, and said plants growing in the soil media with the soil amendment have a reduced metal content.

17. The soil amendment as defined in claim 16, wherein said plants are cabbage plants and said root mass growth rate of said cabbage plants is 6 to 10 times greater than said root mass growth rate of said cabbage plants grown in the control group that was not provided with said soil amendment.

18. The soil amendment as defined in claim 16, wherein said plants are Cannabis plants and said root mass growth rate of said Cannabis plants is 8 to 10 times greater than said root mass growth rate of Cannabis plants grown in the control group that was not provided with said soil amendment.

19. The soil amendment as defined in claim 12, comprising 3-4-deoxyglucosamine monomer, and a dimer thereof, as active ingredients.

20. A process of making a soil amendment with a reduced metal content, said soil amendment increasing a root mass and root mass growth rate of plants grown in the presence of the soil amendment, said process comprising:
a) forming an aqueous suspension of a chitin particulate in aerated and/or oxygenated aqueous media;
b) seeding or inoculating the aqueous suspension of the chitin particulate with an auxin-producing Streptobacillus in order to culture or grow at least one layer of the Streptobacillus on the chitin particulate; and
c) biodegrading the chitin particulate by means of the Streptobacillus so that after a predetermined time period a soil amendment comprising a mixture of plant growth promoting auxins that increase the root mass and root mass growth rate of the plants grown in the presence of the soil amendment but without increasing the metal content of the plants.

21. The process as defined in claim 20, wherein the chitin particulate of step a) is micronized to a particle size of from 5 to 10 microns.

22. The process as defined in claim 21, wherein the chitin particulate of step a) is made by a process comprising fermentation of shrimp and/or crab shell material.

23. The process as defined in claim 22, wherein an unpurified chitin obtained from the fermentation is purified by extraction with an aqueous alkaline media.

24. The process as defined in claim 20, wherein the chitin particulate consists essentially of micronized shrimp and/or crab shell material and said micronized shrimp and/or crab shell material is boiled in aerated or oxygenated water with ample oxygen so that the thereto-tolerant Streptobacillus blooms on the micronized shrimp and/or crab shell material

25. The process as defined in claim 24, wherein the micronized shrimp and/or crab shell has a particle size of from 5 to 100 microns.

26. The process as defined in claim 24, further comprising spinning the aqueous suspension of the chitin particulate and the predetermined time period is at least 24 hours.

27. The process as defined in claim 24, wherein the aerated or oxygenated water is tap water or sea water.

28. The process as defined in claim 20, wherein the auxins comprise 3-4-deoxyglucosamine monomer, and a dimer thereof.

29. A soil amendment made by the process as defined in claim 20.

30. A process of making a soil amendment with a reduced metal content, said soil amendment increasing root mass and root mass growth rates of plants grown in natural or artificial soil media provided with the soil amendment, said process comprising:
fermenting or boiling an aerated or oxygenated aqueous suspension of micronized shrimp and/or crab shell pieces continually supplied with ample air or oxygen in order to spontaneously bloom a plant-auxin-producing Streptobacillus that coats the shrimp and/or crab shell pieces in the suspension, so as to biodegrade the shrimp and/or crab shell pieces to form the soil amendment;
wherein said soil amendment consists essentially of the plant auxins formed during the biodegrading.

31. The process as defined in claim 30, wherein the micronized shrimp and/or crab shell pieces each have particle sizes of from 5 to 100 microns.

32. The process as defined in claim 30, wherein the micronized shrimp and/or crab shell pieces are purified by extraction with an alkaline media to produce the soil amendment with a reduced metal content.

33. The process as defined in claim 30, wherein the plant auxins are 3-4-deoxyglucosamine monomer, and a dimer thereof.

34. A soil amendment made by the process as defined in claim 30.
